(19) United States
(12) Patent Application Publication
(10) Pub. No.: US 2025/0265448 A1
(43) Pub. Date: Aug. 21, 2025

(54) ASYMMETRICALLY DISTRIBUTED CONVOLUTION-ATTENTION NEURAL NETWORKS

(71) Applicant: Snap Inc., Santa Monica, CA (US)

(72) Inventors: Junli Cao, Pittsburgh, PA (US); Anil Kag, Los Angeles, CA (US); Willi Menapace, Santa Monica, CA (US); Jian Ren, Hermosa Beach, CA (US); Aliaksandr Siarohin, Los Angeles, CA (US); Sergey Tulyakov, Santa Monica, CA (US)

(21) Appl. No.: 18/583,605

(22) Filed: Feb. 21, 2024

(51) Int. Cl. G06N 3/0455; G06N 3/0985; G06V 10/82

(52) U.S. Cl. CPC G06N 3/0455; G06N 3/0985; G06V 10/82

(57) ABSTRACT

An asymmetrically distributed convolution-attention neural network (AsCAN) includes a simple hybrid architecture in which the number of convolutional and transformer blocks is asymmetrically distributed in different processing stages. AsCAN adopts more convolutional blocks in the early processing stages, where the feature maps have relatively large spatial sizes, and more transformer blocks at the later processing stages. Transformer layers are incorporated in the early processing stages as well, except that fewer transformer blocks are used compared to convolutions in the early part. This trend is reversed at the lower resolution in the later processing stages. This uneven distribution of the convolutional and transformer blocks yields better throughput due to improved accelerator utilization at various batch sizes during the inference stage.

### TECHNICAL FIELD

Examples set forth herein generally relate to a neural network architecture for solving computer vision tasks and, in particular, to a neural network in which convolutional and transformer layers are asymmetrically distributed to improve inference latency.

### BACKGROUND

Over the past decade, Convolutional Neural Networks (CNNs) have achieved unprecedented performance on many computer vision tasks. Early CNNs were improved upon by various design changes such as residual connections, dense connections, low-rank operator decomposition, fused kernel operators, neural architecture search, and the like. Despite these modifications to enhance the model, CNNs still face limitations and their receptive field has been local and pretty restrictive. Numerous efforts have been conducted to try to address this challenge by applying various mechanisms, including channel-wise attention, ordinary and partial differential equations, and large kernel convolutions.

The transformer architecture for vision transformers (ViTs), initially designed for sequential tasks, undergoes a transformative application to vision applications with the creation of the Vision Transformer model, treating images as sequences of tokens. This approach facilitates the computation of the global dependencies between tokens, improving the receptive field compared to the CNNs. Recent developments have improved the data and training efficiency of the vision transformers. However, the ViTs come with quadratic computation complexity concerning input resolution. To address such a challenge, many prior art studies attempt to build more efficient attention operations, such as shifting window and sparse attention calculations.

Recently, there has been a growing interest in exploring models that go beyond pure convolutional or transformer layers, such as those built upon fully connected layers. A particularly promising area is to combine convolutional and transformers blocks within a single architecture to derive the best of both these worlds, namely, the spatial and translational priors from the convolutions and global receptive fields from the attention mechanism. These hybrid architectures can be further upscaled to a supernet and optimized through network searching techniques to obtain the models with improved latency.

Both convolutional neural networks (CNNs) and transformers have been deployed in a wide spectrum of real-world applications, addressing various computer vision tasks, including image recognition, object detection, semantic segmentation, image generation, and the like. CNNs encode many desirable properties like translation invariance facilitated through the convolutional operators. However, CNNs lack the input-adaptive weighting and the global receptive field capabilities offered by transformers. Recognizing the potential benefits of combining these complementary strengths, recent research endeavors explore hybrid architectures that integrate both convolutional and attention mechanisms.

One prominent research area in the development of hybrid models involves the creation of building blocks that can effectively combine convolutional and attention operators. For example, MaxViT employs a combination of convolutions and axial attention layers (a variant of local attention) to introduce building blocks that mitigate the quadratic complexity of the attention mechanism. Similarly, the most recent work of FasterViT proposes hierarchical attention layers to replace the global attention. While these efforts seek to leverage the strengths of both convolutional and transformer operators, their faster attention alternatives only approximate the global attention, leading to compromised model performance due to a lack of global receptive field. As a result, these models necessitate the incorporation of additional layers to compensate for the capacity reduction due to the attention approximation. On the other hand, minimal effort has been directed toward optimizing the entire hybrid architecture.

The advances in hybrid architectures, e.g., networks combining convolutional and transformer blocks, have solidified their position as the preferred model choice for various computer vision tasks. This is primarily attributed to their exceptional trade-off between latency and performance, surpassing that of purely convolutional or transformer-based models. Recent endeavors in this domain typically adopt a straightforward symmetric architecture design. Namely, the number of convolutional and transformer blocks are distributed evenly in each stage, e.g., a model with the first two stages consisting of only convolutional blocks and the last two stages with only transformer blocks.

### BRIEF DESCRIPTION OF THE DRAWINGS

In the drawings, which are not necessarily drawn to scale, like numerals may describe similar components in different views. Some nonlimiting examples are illustrated in the figures of the accompanying drawings in which:

FIG. 1A is a diagram illustrating a neural network including four processing stages where the number of convolutional and transformer blocks in the processing stages is asymmetrically distributed in a sample configuration.

FIG. 1B is a diagram illustrating an alternative configuration where the number of convolutional and transformer blocks in the processing stages is asymmetrically distributed in a sample configuration.

FIG. 1C is a diagram illustrating another alternative configuration where the number of convolutional and transformer blocks in the processing stages is asymmetrically distributed in a sample configuration.

FIG. 2A is a diagram of a sample convolutional block.

FIG. 2B is a diagram of a sample transformer block.

FIG. 3 is a flow chart of a method of processing input visual datasets using an asymmetrically distributed convolution-attention neural network of the type shown in FIGS. 1A-1C.

FIG. 4 is a block diagram of a machine within which instructions (e.g., software, a program, an application, an applet, an app, or other executable code) for causing the machine to perform one or more of the methodologies discussed herein may be executed.

FIG. 5 is a block diagram showing a software architecture within which examples described herein may be implemented.

### DETAILED DESCRIPTION

In contrast to adopting efficient attention mechanisms, the inventors have recognized that optimizing the macro architecture directly allows use of the original attention for a superior latency-performance trade-off compared to existing approaches. The systems and methods described herein revisit the design choices of the hybrid architectures and provide a new design that has a fast runtime while maintaining high performance.

The following description relates to a very simple yet effective asymmetric architecture in which the distribution of the convolutional and transformer blocks is asymmetric in the different blocks. More convolutional blocks are applied to the early stages of the model with relatively large spatial feature maps, and more transformer blocks are utilized at the later stages. To assess the efficacy of the model, experiments were performed including image classification on ImageNet-1K, object detection and instance segmentation on MS-COCO, and image segmentation on ADE20K. As will be shown, the asymmetric models consistently outperformed prior art models, achieving a state-of-the-art trade-off between performance and latency. Notably, even without any computation optimization for transformer blocks, the architecture design described herein still yields faster inference speed than existing models featuring efficient attention mechanisms. In sample configurations, the attention operations are leveraged to obtain a better global understanding of the feature maps.

The asymmetrically distributed convolution-attention neural network (AsCAN) described below includes a simple hybrid architecture in which the number of convolutional and transformer blocks is asymmetrically distributed in different stages. The architecture differs from existing models like MaxViT and FasterViT, which apply naive repetitions of convolutional and transformer blocks. Specifically, AsCAN adopts more convolutional blocks in the early stages, where the feature maps have relatively large spatial sizes, and more transformer blocks at the later stages. While transformer layers have been utilized towards the later part of a model that processes lower resolution feature maps and applies convolutions in the early part of the model, the system and method described herein incorporates transformer layers in the early stage as well, except that it uses fewer transformer blocks compared to convolutions in the early part and reverses this trend at the lower resolution. As a result, this uneven distribution of the convolutional and transformer blocks yields better throughput due to improved accelerator utilization at various batch sizes during the inference stage.

The following description revisits designs of hybrid convolutional-transformer models and proposes an architecture with asymmetrically distributed convolutional and transformer blocks. Extensive latency analysis is provided to show that the asymmetrically distributed convolutional and transformer blocks provide a model that can achieve superior throughput-performance trade-offs than existing models on various benchmark datasets. Notably, the model performance is shown to be significantly improved even without any acceleration optimization on attention operations. The applicability of pre-trained models on ImageNet-1K to downstream tasks, including image segmentation and object detection, are also validated.

In sample configurations, a neural network is described that performs a computer task such as a computer vision task. The neural network includes a convolutional stem that receives input data; a first processing stage comprised of convolutional (C) blocks that receives an output of the convolutional stem; one or more early asymmetric processing stages having more C blocks than transformer (T) blocks out of a total number of blocks N, the one or more early asymmetric processing stages processing an output of the first processing stage; and one or more late asymmetric processing stages having more T blocks than C blocks out of the total number of blocks N, the one or more late asymmetric processing stages processing an output of the one or more early asymmetric processing stages to provide a result of the computer task on the input data. A pooling and classifier block also may be provided to pool an output of the one or more late asymmetric processing stages and to classify a result of the pooling as the result of the computer task.

In the sample configurations, at least one early asymmetric processing stage comprises a number of C blocks ranging from 60% to 90% of N and a number of T blocks ranging from 40% to 10% of N, respectively. In such configurations, at least one late asymmetric processing stage comprises a percentage of T blocks and C blocks that is reversed from the percentage of T blocks and C blocks used in the at least one early asymmetric processing stage.

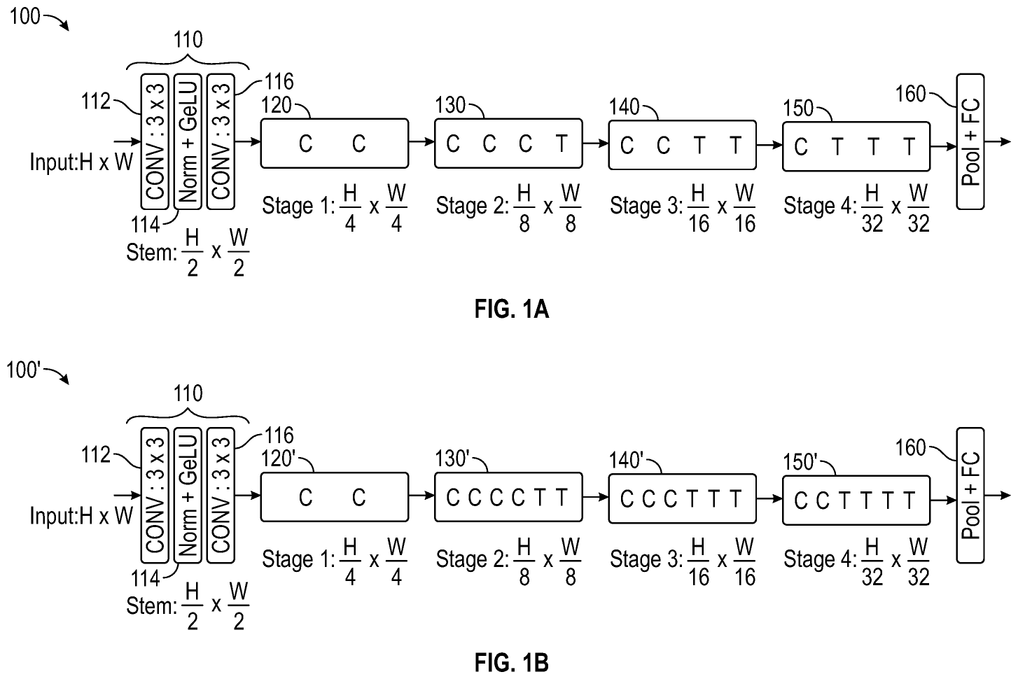

A detailed description of the asymmetrically distributed convolution-attention neural networks will now be described with reference to FIGS. 1-5. Although this description provides a detailed description of possible implementations, it should be noted that these details are intended to be exemplary and in no way delimit the scope of the inventive subject matter.

In the following description, X∈ [symbol] ^{H×W×C} is used to represent the input feature map that has H×W spatial dimensions along with C channels. Y∈ [symbol] ^{H′×W′×C′} is denoted as the output of a building block (convolutional or transformer). The symbol ∘ is used to denote the function composition operator.

### Building Blocks

### Convolutional Block (C)

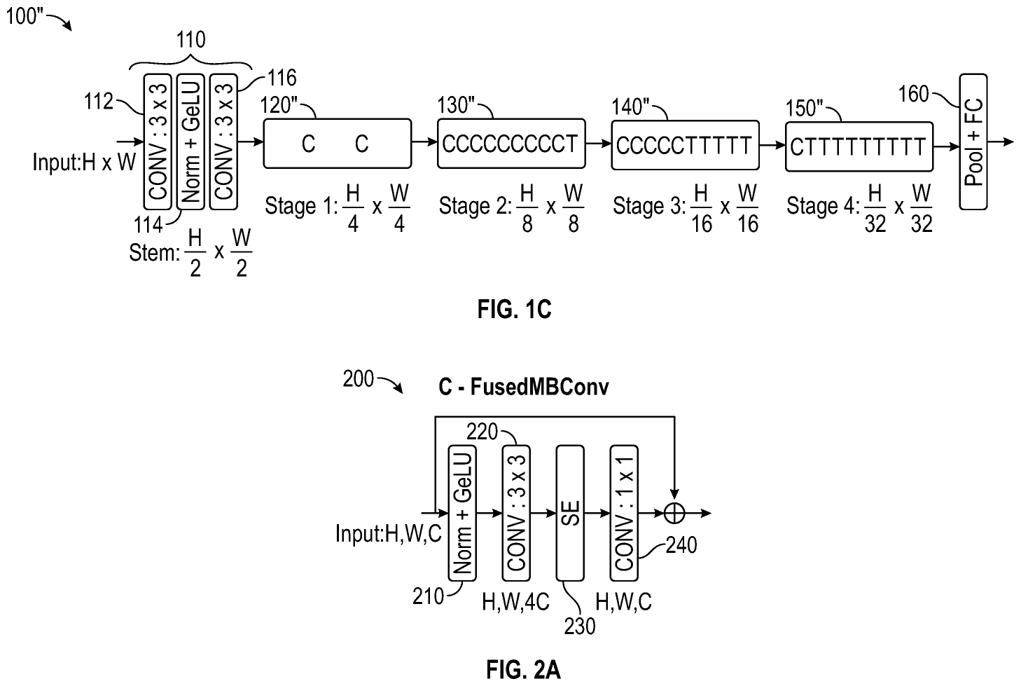

There are various choices for designing a convolutional building block that can be used in the asymmetrical architecture described herein, such as MBConv, FusedMBConv (FIG. 2A), and ConvNeXt. While MBConv block has been used in many networks, the presence of depthwise convolutions results in low accelerator utilization for high-end graphics processing units (GPUs).

In order to better understand the throughput-performance trade-off for various convolutional blocks, the same hybrid architecture is provided but with different convolutional blocks. Specifically, the following convolutional blocks are used: ConvNext, MBConv, and FusedMBConv. For each of them, the hybrid architecture was trained on the ImageNet-1K dataset for the classification task, with the setup described below. Table 1 shows the inference latency along with the top-1 accuracy. As can be seen, FusedMBConv has better throughput on A100 and V100 GPUs than the other two options, while maintaining high-performance. Therefore, FusedMBConv (C) was adopted for the convolutional block in a sample configuration.

Formally, the FusedMBConv may be represented using the following update equation:

$$Y = X + 𝒫 \cdot 𝒮ℰ \cdot 𝒞 ( X ) , \qquad ( 1 )$$

where [symbol] is a full 3×3 convolution with 4× channel expansion followed by batch norm and Gaussian Error Linear Unit (GeLU) non-linearity, [symbol] is a squeeze-and-excite operator with shrink ratio of 0.25, and [symbol] is a 1×1 convolution to project channels to C dimension.

Table 1 illustrates an analysis of sample convolutional blocks performed by training hybrid architectures with different options on the ImageNet-1K dataset for the image classification task. The throughput for different GPUs is also provided. The results show that FusedMBConv provides a better trade-off over accuracy and latency.

TABLE 1

| | | Throughput (images/s) | | | |
|---|---|---|---|---|---|
| | | A100 | | V100 | Top-1 |
| Block | Params | B = 16 | B-64 | B = 16 | Accuracy |
| MBConv | 29M | 2564 | 3013 | 914 | 83.12% |
| ConvNext | 35M | 3132 | 3923 | 1104 | 82.81% |
| FusedMBConv | 55M | 3224 | 4295 | 1148 | 83.44% |

### Transformer Block (T)

Similar to the convolutional blocks, there are many choices for the transformer block, e.g., blocks containing efficient attention mechanisms like multi-axial attention and hierarchical attention.

To decide the best transformer block in the hybrid architecture described herein, the models were trained with different options on the ImageNet-1K dataset. As can be seen from Table 2, the vanilla attention (O(n²) mechanism (in which each pixel has n² dependencies as opposed to the n, n sqrt(n), or n log(n) dependencies of other conventional transformer blocks) provides a better accuracy versus throughput trade-off across different GPUs and batch sizes. Thus, the vanilla attention was chosen as transformer block (T) in a sample configuration (FIG. 2B). The vanilla transformer block can be expressed with the following update equations:

$${X}_{norm} = ℒ𝒩 \cdot ϕ ( X ) , {Y}_{attn} = 𝒫 \cdot 𝒜 \cdot {𝒫}_{Q K V} ( {X}_{norm} ) , {Y}_{mlp} = 𝒫 \cdot ϕ \cdot {𝒫}_{M L P} ( {X}_{n o r m} ) , Y = X + {Y}_{a t t n} + {Y}_{mlp} , \qquad ( 2 )$$

where [symbol] denotes layer normalization, denotes the GeLU non-linearity, [symbol] is the multi-headed self-attention function, [symbol] _{QKV} & [symbol] _{MLP} denote the linear projection to the key value query (KVQ) and multilayer perceptron (MLP) space, respectively, and [symbol] denotes the projection operator to the same space as the input. These update equations are inspired approaches where the feed-forward and the self-attention operators are arranged in parallel in order to get improved throughput with marginal reduction in performance.

Table 2 illustrates results of analysis of transformer blocks as a result of training hybrid architectures with different options on a ImageNet-1K dataset for the image classification task. The throughput is provided for different GPUs. The results show that the vanilla transformer block provides a better trade-off over accuracy and latency.

TABLE 2

| | | Throughput (images/s) | | | |
|---|---|---|---|---|---|
| | | A100 | | V100 | Top-1 |
| Block | Params | B = 16 | B-64 | B = 16 | Accuracy |
| Multi-Axial | 83M | 1844 | 3541 | 630 | 83.59% |
| Hierarchical | 74M | 1703 | 3470 | 552 | 83.51% |
| Vanilla | 55M | 3224 | 4295 | 1148 | 83.44% |

### Architectural Design

After selecting the basic building blocks, e.g., FusedMBConv (C) for the convolutional block and the Vanilla Transformer (T) for the transformer block, the convolutional blocks and transformer blocks are arranged in a macro design for the hybrid architecture. In a sample configuration, a four-stage processing architecture is used (excluding the convolutional stem at the beginning and classifier components at the end). The processing blocks may be arranged in a number of ways. For instance, CoAtNet stacks convolutional blocks in the first two stages and transformer blocks in the remaining stages. On the other hand, MaxViT stacks convolutional and transformer blocks alternatively, throughout the entire network.

The strategy for arranging the convolutional blocks and transformer blocks in accordance with the present description is based on the following principles:
C before T. In any stage, convolutional blocks followed by transformer blocks are preferred to capture the global dependence between the features aggregated by the convolutions, as they can capture scale and translation-aware information.
Fixed first stage. As transformer blocks have quadratic computation complexity in terms of the sequence length (in this case, spatial size), it is preferred that the first stage contain only convolutional blocks, such that the inference throughput can be improved.
Equal blocks in remaining stages. For the ease of analysis, the number of blocks in the remaining stages is fixed, i.e., stages 2 to 4, to be four (FIG. 1A). Once the basic configuration is finalized, these stages can be scaled as shown in FIGS. 1B and 1C to achieve larger models.
Asymmetric vs Symmetric. An architecture is referred to as symmetric whenever C and T blocks are distributed equally within a stage. For example, a configuration of CCCC-CCTT-TTTT is symmetric since both C and T blocks are equal within a stage. In contrast, the configuration of CCCT-CCTT-CTTT is asymmetric since the number of C and T blocks are not equal in stages 2 and 4. In example configurations, asymmetric architectures having convolutional blocks that make up 60%-90% of a stage may be paired with transformer blocks that make up 40%-10% of a stage, respectively.

Given the above design principles, various promising configurations based on the building blocks (C & T) were provided and their inference throughput and accuracy was analyzed on ImageNet-1K for the image classification task. Table 3 provides these configurations along with performance and runtime on different GPUs. For a better comparison with existing architectures, the configurations of CoAtNet and MaxViT are also provided for reference. From the results, the following conclusions can be drawn:
Compared to symmetric architecture design, asymmetric distribution of C & T blocks yield a better trade-off for throughput and accuracy, as shown by comparison of configurations C1-C5 versus C6-C10.
A higher number of transformer blocks in the early stages result in lower throughput, which can be observed by comparing the latency for the configurations of C1 versus C10, and C8 versus C9.
While increasing the number of transformer blocks in the network improves the throughput, it does not result in improved accuracy, as demonstrated by C6 versus C9.

Table 3 illustrates the results of an analysis of the distribution of convolutional and transformer blocks by training hybrid architecture with different distributions of blocks on the ImageNet-1K dataset. It demonstrates that the design in FIG. 1A provides a better trade-off over accuracy and latency. Symbol M denotes MaxViT block composed of MBConv and Multi-Axial Attention blocks, which is equivalent to CT. It is noted that CoAtNet uses MBConv blocks compared to the FusedMBConv blocks in the FIG. 1A design.

TABLE 3

| | | | Throughput (images/s) | | | |
|---|---|---|---|---|---|---|
| | | | A100 | | V100 | Top-1 |
| Family | Block Configuration | Params | B = 16 | B = 64 | B = 16 | Accuracy |
| Asymmetric | CC-CCCT-CCTT-CTTT (C1) | 55M | 3224 | 4295 | 1148 | 83.4% |
| | CC-CCCT-CCTT-CCTT (C2) | 73M | 3217 | 4179 | 1036 | 83.2% |
| | CC-CCCT-CCTT-TTTT (C3) | 41M | 3384 | 4472 | 1224 | 82.9% |
| | CC-CCCT-CCCC-TTTT (C4) | 50M | 3434 | 4411 | 1182 | 83.1% |
| | CC-CCCT-CCCT-CCCT (C5) | 95M | 3135 | 4066 | 991 | 82.7% |
| Symmetric | CC-CCCC-CCCC-TTTT (C6) | 51M | 3783 | 4998 | 1280 | 82.8% |
| | CC-CCCC-CCTT-TTTT (C7) | 42M | 3536 | 4941 | 1296 | 82.4% |
| | CC-CCCC-TTTT-TTTT (C8) | 34M | 3475 | 5311 | 1469 | 82.6% |
| | CC-TTTT-TTTT-TTTT (C9) | 30M | 3216 | 4091 | 1293 | 82.7% |
| | CC-CCTT-CCTT-CCTT (C10) | 72M | 2942 | 3820 | 980 | 82.8% |
| CoAtNet-0 | CC-CCC-TTTTT-TT | 25M | 3537 | 5221 | 976 | 81.6% |
| CoAtNet-1 | CC-CCCCCC- | 42M | 2221 | 2907 | 629 | 83.3% |
| | TTTTTTTTTTTTTT-TT | | | | | |
| MaxViT-T | MM-MM-MMMMM-MM | 31M | 1098 | 2756 | 357 | 83.6% |

Table 3 illustrates several promising candidates with similar performance and latency trade-off. It shows that an asymmetric design has more advantages compared to the symmetric template used in the prior art.

Given this analysis, the C1 configuration is selected in an exemplary embodiment for its simplicity along with better accuracy versus latency trade-off. Since transformer blocks capture global dependencies, it is preferred that at least some transformer blocks be included in the early layers in conjunction with the convolutional blocks. Similarly, it is preferred that at least a few convolutional blocks be included in the later stages to capture the spatial, translation, or scale aware features.

FIG. 1A is a diagram illustrating a neural network 100 having the C1 architectural configuration where the neural network 100 includes four processing stages and the number of convolutional and transformer blocks in the processing stages is asymmetrically distributed for an image classification task in a sample configuration. Of course, the architecture may be used to process other types of data to complete classification tasks. The exemplary C1 architectural configuration 100 shown in FIG. 1A includes a convolutional stem 110 followed by four processing stages 120-150 and the classifier head 160 including pooling (to reduce spatial dimensions of feature maps) and a classifier.

The convolutional stem 110 receives visual input data in height (H) by width (W) format in a convolutional layer (e.g., 3×3) 112 and provides the output of the convolutional layer 112 to a batch norm and Gaussian Error Linear Unit (GeLU) non-linearity layer 114, the output of which is provided to another convolutional layer (e.g., 3×3) 116. The output of the convolutional layer 116 is provided to the first stage 120.

In the first stage 120, only convolutional blocks are used. In the second stage 130, 75% convolutional blocks and 25% transformer blocks are used. This trend is reversed in the fourth (final) stage 150 where 25% convolutional blocks and 75% transformer blocks are used. For the third stage 140, an equal number of convolutional and transformer blocks are used.

It will be appreciated that other asymmetric configurations are possible. For example, more or less than four processing stages may be used. Also, more or less than four convolution/transformer blocks may be used in each processing stage. In addition, asymmetry may be provided over a range. For example, as noted above, asymmetric architectures having convolutional blocks that make up 60%-90% of a stage may be paired with transformer blocks that make up 40%-10% of a stage, respectively. Those skilled in the art will appreciate that the architectural configuration of FIG. 1A may be scaled to larger model sizes.

For example, FIG. 1B is a diagram illustrating an alternative configuration 100′ where the number of convolutional and transformer blocks in the processing stages is asymmetrically distributed in a sample configuration. In FIG. 1B, processing stages 2-4 each include six transformer blocks. As shown, in the first processing stage 120′, only convolutional blocks are used. In the second processing stage 130′, ⅔ convolutional blocks and ⅓ transformer blocks are used. This trend is reversed in the final processing stage 150′ where ⅓ convolutional blocks and ⅔ transformer blocks are used. For the third processing stage 140′, an equal number of convolutional and transformer blocks are used.

FIG. 1C is a diagram illustrating another alternative configuration 100″ where the number of convolutional and transformer blocks in the processing stages is asymmetrically distributed in a sample configuration. In FIG. 1C, processing stages 2-4 each include ten transformer blocks. As shown, in the first processing stage 120″, only convolutional blocks are used. In the second processing stage 130″, 90% convolutional blocks and 10% transformer blocks are used. This trend is reversed in the final processing stage 150″ where 10% convolutional blocks and 90% transformer blocks are used. For the third processing stage 140″, an equal number of convolutional and transformer blocks are used.

FIG. 2A is a diagram of a sample convolutional block 200. The FusedMBConv convolutional block 200 may be represented using the update equation (1) where the convolutional block includes a batch normalization and Gaussian Error Linear Unit (GeLU) non-linearity activation layer 210 followed by a full 3×3 convolution layer 220 with 4× channel expansion, a squeeze-and-excite operator 230 with a shrink ratio of 0.25, and a 1×1 convolution layer 240 to project channels to a C dimension. As noted above, other convolutional blocks may be used, although FusedMBConv has been shown to provide a better trade-off over accuracy and latency relative to conventional convolutional blocks.

FIG. 2B is a diagram of a sample vanilla attention transformer block 250. The vanilla transformer block 250 can be expressed with the update equations of Equation (2) and includes a batch normalization and Gaussian Error Linear Unit (GeLU) non-linearity activation layer 260 followed by a linear projection layer 270 to the key value query (KQV) and multilayer perceptron (MLP) space. The key value query parameters are provided to an attention and projection layer 280, while the MLP parameters are provided to an activation (GeLU) and projection layer 290. The outputs of the attention and projection layer 280 and activation and projection layer 290 are summed and provided as output of the transformer block 250. As noted above, other transformer blocks may be used, although the vanilla transformer block has been shown to provide a better trade-off over accuracy and latency relative to conventional transformer blocks.

Existing approaches have improved the quadratic complexity of the attention mechanism; however, the improvement comes with the cost of additional overhead in terms of operator complexity and reduced network capacity. More importantly, these variants need not be supported out-of-the-box by existing hardware accelerators. On the other hand, the asymmetric design described herein provides a simple architecture with a vanilla attention mechanism to overcome these limitations.

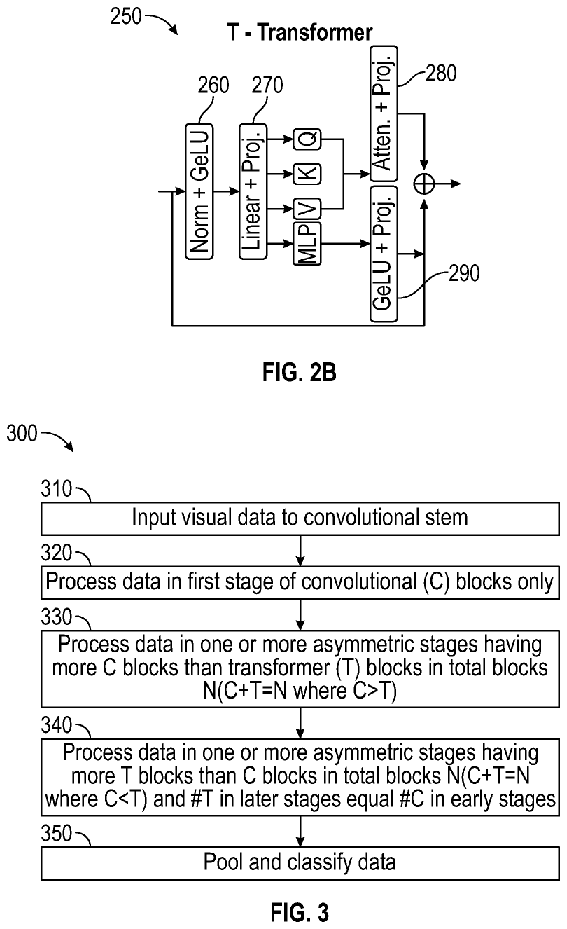

FIG. 3 is a flow chart of a method 300 of processing input visual datasets using an asymmetrically distributed convolution-attention neural network of the type shown in FIGS. 1A-1C.

As illustrated in FIG. 3, the input visual data (e.g., H×W) is provided to a convolutional stem at 310 that, for example, reduces the size of the dataset to (H/2×W/2). The resulting data is provided to a first processing stage comprised of convolutional (C) blocks at 320 to improve inference throughput. The output of the first processing stage is then processed at 330 in one or more asymmetric processing stages having more C blocks than transformer (T) blocks out of a total number of blocks N. In other words, C+T=N, where C>T. In sample configurations, the number of C blocks ranges from 60% to 90% of N, where T ranges from 40% to 10% of N. The data output by the one or more asymmetric processing stages at 330 is then processed at 340 in one or more asymmetric processing stages having more T blocks than C blocks out of the total number of blocks N. In this case, C+T=N, where C<T. Also, the number of T blocks and C blocks in the later stages is reversed from the number of T blocks and C blocks in the early stages. For example, if early stages are 75% C blocks and 25% T blocks, then the later stages are 25% C blocks and 75% T blocks. Finally, the resulting data is pooled and classified at 350. In sample configurations, the C blocks precede the T blocks in each processing stage.

Although one skilled in the art can come up with a better architectural design for fixed hardware, e.g., a specific batch size for a specific GPU, it is harder to design architectures that can scale similarly across different accelerators and under different batch sizes. Thus, a comprehensive evaluation was performed to evaluate the inference latency of the asymmetric design along with the baselines on two different yet both widely used GPUs (NVIDIA A100 & V100) with varying batch sizes. The results are outlined in Table 4 below.

Table 4 illustrates results on the ImageNet-1K dataset for a classification task comparing the performance of the asymmetric architectures described herein against baselines. The inference latency is reported as the throughput (images per second) that is measured by inferring images with batch size as B in half-precision, i.e., B=1 for one image at a time B=16 for fp16, on an A100 GPU using torch-compile and benchmark utility from the timm library. A similar procedure (without torch-compile) was followed to obtain the throughput on the V100 GPU.

TABLE 4

| | | | | | Throughput (images/s) Batch (B) | | | | | |
|---|---|---|---|---|---|---|---|---|---|---|
| | | | | | A100 | | | V100 | | Top-1 |
| Architecture | | Res. | Params. | MACs | B = 1 | B = 16 | B = 64 | B = 1 | B = 16 | Accuracy |
| ConvNet | EfficientNet-B6 | 528 | 43M | 19.0G | 88 | 529 | 589 | 27 | 205 | 84.0% |
| | EfficientNet-B7 | 600 | 66M | 37.0G | 72 | 321 | 350 | 24 | 124 | 84.3% |
| | NFNet-F0 | 256 | 72M | 12.4G | 199 | 2470 | 3348 | 47 | 813 | 83.6% |
| | NFNet-F1 | 320 | 132M | 35.5G | 106 | 998 | 1192 | 26 | 48 | 84.7% |
| | EfficientNetV2-S | 384 | 24M | 8.8G | 112 | 1884 | 2744 | 34 | 561 | 83.9% |
| | EfficientNetV2-M | 480 | 55M | 24.0G | 84 | 918 | 1094 | 26 | 329 | 85.1% |
| | ConvNeXt-S | 224 | 50M | 8.7G | 174 | 2291 | 2889 | 56 | 836 | 83.1% |
| | ConvNeXt-B | 224 | 89M | 15.4G | 167 | 1760 | 2073 | 58 | 619 | 83.8% |
| | ConvNeXt-L | 224 | 198M | 34.4G | 168 | 1045 | 1127 | 58 | 362 | 84.3% |
| ViT | ViT-B/16 | 384 | 86M | 55.4G | 212 | 1006 | 1266 | 104 | 86 | 77.9% |
| | ViT-B/32 | 384 | 307M | 190.7G | 112 | 893 | 924 | 54 | 27 | 76.5% |
| | DeiT-B | 384 | 86M | 55.4G | 189 | 1058 | 1192 | 130 | 488 | 83.1% |
| | Swin-S | 224 | 50M | 8.7G | 50 | 841 | 2221 | 34 | 436 | 83.0% |
| | Swin-B | 384 | 88M | 47.0G | 51 | 458 | 486 | 20 | 85 | 84.5% |
| | CoAtNet-0 | 224 | 25M | 4.2G | 214 | 3537 | 5221 | 61 | 976 | 81.6% |
| | CoAtNet-1 | 224 | 42M | 8.4G | 141 | 2221 | 2907 | 45 | 629 | 83.3% |
| | CoAtNet-2 | 224 | 75M | 15.7G | 133 | 1718 | 2040 | 38 | 540 | 84.1% |
| | CoAtNet-3 | 224 | 168M | 34.7G | 132 | 1085 | 1105 | 37 | 388 | 84.5% |
| Hybrid | MaxViT-T | 224 | 31M | 5.6G | 73 | 1098 | 2756 | 23 | 357 | 83.62% |
| | MaxViT-S | 224 | 69M | 11.7G | 70 | 1019 | 1775 | 24 | 243 | 84.45% |
| | MaxViT-B | 224 | 120M | 23.4G | 34 | 507 | 1012 | 11 | 164 | 84.95% |
| | MaxViT-L | 224 | 212M | 43.9G | 34 | 544 | 759 | 10 | 123 | 85.17% |
| | FasterViT-1 | 224 | 53M | 5.3G | 67 | 1123 | 4106 | 23 | 363 | 83.2% |
| | FasterViT-2 | 224 | 76M | 8.7G | 64 | 1112 | 4376 | 24 | 321 | 84.2% |
| | FasterViT-3 | 224 | 160M | 18.2G | 46 | 831 | 3131 | 17 | 257 | 84.9% |
| | FasterViT-4 | 224 | 425M | 36.6G | 50 | 800 | 1392 | 18 | 234 | 85.4% |
| | AsCAN -T (tiny) | 224 | 55M | 7.7G | 199 | 3224 | 4295 | 67 | 1148 | 83.44% |
| | AsCAN -B (base) | 224 | 98M | 16.7G | 113 | 1878 | 2393 | 38 | 590 | 84.73% |
| | AsCAN -L (large) | 224 | 173M | 30.7G | 120 | 1381 | 1617 | 40 | 440 | 85.24% |

Many of the design choices described herein can be set as configuration options in the architecture search space, e.g., as the initialization of the super-net. In this process, a neural architecture search (NAS) procedure can be leveraged to find a few suitable candidates to further optimize the latency-performance trade-off. While it is possible that NAS can yield better candidates, there are many caveats. For example, the sheer size of the search options would render the search to be quite intractable. To alleviate this, design priors may be introduced. For instance, in the asymmetric design described herein, some transformer blocks are provided in the early part of the network to achieve a balance between computation and performance. Given such a prior, it should be possible to leverage NAS to find better candidates with reduced computation cost.

AsCAN variants (tiny, base, and large) were used in experiments, and the results are shown in Tables 4 and 5. The tiny variant was scaled as described above. It is noted that the convolutional stem 110 consists of two convolutional layers which downsample the input to half spatial resolution. The classifier stage projects the final feature map to the corresponding embedding size and performs adaptive average pooling to reduce the spatial dimensions to 1×1 in order to apply the feed-forward layer that acts as a classifier head on top of these pooled features. The convolutional blocks use the batch-norm as the normalization layer while the transformer blocks leverage the layer-norm as the normalization layer. The relative positional embeddings are learned in the attention mechanism.

Table 5 provides the detailed configurations of the three variants of AsCAN used in the experimentation, namely, tiny, base, and large. In the experiments FusedMBConv (C) is used as the convolutional block and Vanilla Transformer (T) is used as the transformer block. K is used to denote the number of classes. The activation and normalization layers are hidden in the blocks. The GeLU activation and batch-normalization are provided in the convolutional stem 110 as well as the classifier stages 120-150 described with respect to FIG. 1A.

TABLE 5

| Stage | Tiny | Base | Large |
|---|---|---|---|
| S0: Stem | Conv 3 × 3, Channels | Conv 3 × 3, Channels | Conv 3 × 3, Channels |
| | 64, Stride 2 | 64, Stride 2 | 128, Stride 2 |
| | Conv 3 × 3, Channels | Conv 3 × 3, Channels | Conv 3 × 3, Channels |
| | 64, Stride 1 | 64, Stride 1 | 128, Stride 1 |
| S1: Only-Conv | C, Channels 96, | C, Channels 96, | C, Channels 128, |
| | Stride 2 | Stride 2 | Stride 2 |
| | C, Channels 96, | C, Channels 96, | C, Channels 128, |
| | Stride 1 | Stride 1 | Stride 1 |
| S2: Mix | C, Channels 192, | (C, Channels 192, | (C, Channels 256, |
| | Stride 2 | Stride 2) × 1 | Stride 2) × 1 |
| | C, Channels 192, | (C, Channels 192, | (C, Channels 256, |
| | Stride 1 | Stride 1) × 3 | Stride 1) × 3 |
| | C, Channels 192, | (T, Channels 192, | (T, Channels 256, |
| | Stride 1 | Stride 1) × 2 | Stride 1) × 2 |
| | T, Channels 192, | | |
| | Stride 1 | | |
| S3: Mix | C, Channels 384, | (C, Channels 384, | (C, Channels 512, |
| | Stride 2 | Stride 2) × 1 | Stride 2) × 1 |
| | C, Channels 384, | (C, Channels 384, | (C, Channels 512, |
| | Stride 1 | Stride 1) × 6 | Stride 1) × 6 |
| | T, Channels 384, | (T, Channels 384, | (T, Channels 512, |
| | Stride 1 | Stride 1) × 7 | Stride 1) × 7 |
| | T, Channels 384, | | |
| | Stride 1 | | |
| S4: Mix | C, Channels 768, | C, Channels 768, | C, Channels 1024, |
| | Stride 2 | Stride 2 | Stride 2 |
| | T, Channels 768, | T, Channels 768, | T, Channels 1024, |
| | Stride 1 | Stride 1 | Stride 1 |
| | T, Channels 768, | T, Channels 768, | T, Channels 1024, |
| | Stride 1 | Stride 1 | Stride 1 |
| | T, Channels 768, | T, Channels 768, | T, Channels 1024, |
| | Stride 1 | Stride 1 | Stride 1 |
| S5: Classifier | Conv 1 × 1, Channels | Conv 1 × 1, Channels | Conv 1 × 1, Channels |
| | 512 | 768 | 1024 |
| | Adaptive Avg Pool | Adaptive Avg Pool | Adaptive Avg Pool |
| | Feed-Forward | Feed-Forward | Feed-Forward |
| | 512 × K | 768 × K | 1024 × K |

### Experiments

### Datasets

The architecture described herein was evaluated against existing state-of-the-art baselines on the following benchmark datasets for various tasks:
ImageNet-1K is a widely used image recognition dataset consisting of 1.28M training images and 50K validation images corresponding to 1K classes. The primary experiments train the architectures with an input resolution of 224×224. The standard data augmentation for training was used, such as RandAugment and MixUp.
MS-COCO is a challenging object detection and instance segmentation dataset. The popular 2017 version of this dataset was used, which consists of 118K train and 5K validation images over 80 object categories.
ADE20K is a popular scene-parsing dataset used to evaluate the semantic segmentation performance. It consists of 20K train and 2K validation images over 150 fine-grained semantic categories. Images are resized and cropped to 512×512 resolution for training.

The models trained on ImageNet-1K were utilized as the backbone to initialize the training for object detection and semantic segmentation tasks, which can be used to verify the performance of downstream tasks. It will be appreciated that other models may be used for other tasks in other settings for different applications.

### Evaluation Protocol

The performance metrics are reported herein based on the publicly used validation splits, namely, top-1 accuracy on ImageNet, mIoU on ADE20K, and mean precision on COCO. The storage (parameters) and inference latency (throughput and the number of floating point parameters) are also reported to compare the model footprint. Throughput is shown as the samples processed per second on A100 and V100 GPUs with different batch sizes.

### ImageNet Classification

Experimental Setup. Different architecture variants of the asymmetric architecture were trained on the ImageNet-1K classification task. Conventional hyper-parameter setups were used. These models were trained with the AdamW optimizer for 300 epochs with a total batch size of 4096 using 64 A100 GPUs. Conventional augmentation strategies also were used.

Experimental Results. Table 4 shows the performance, computational, and storage footprint of the asymmetric architecture described herein (AsCAN) and compares the same with existing state-of-the-art networks. The following can be observed from these experiments:
More than 2× higher throughput across accelerators. Compared to the existing hybrid architectures such as FasterViT and MaxViT, the AsCAN family achieves similar or better top-1 accuracy with more than 2× higher throughput. This trend holds true for both A100 and V100 GPUs. For instance, on A100 with batch=16, FasterViT-1 achieves 83.2% top-1 accuracy with throughput as 1123 images/s, while AsCAN-T has 83.44% with throughput as 3224 images/s.
Better throughput across different batch sizes. AsCAN consistently achieves better throughput across batch sizes for both the accelerators compared to baselines.
Better storage and computational footprint. The AsCAN family of architectures requires fewer parameters and float operations to achieve similar performance. For example, to achieve nearly 85.2% accuracy, MaxViT-L requires 212M parameters and 43.9G MACs whereas AsCAN-L requires 173M parameters and 30.7G MACs.

The AsCAN architectures trained on the ImageNet-1K classification dataset are also scaled to higher input resolution. The models trained with 224 input resolution are fine tuned to 512 resolution. Table 6 shows the performance of these models alongside the MaxViT baselines. Table 6 shows that the AsCAN models can easily scale to larger input resolutions while still providing similar gains.

Table 6 illustrates the performance of models pre-trained on ImageNet-1K with 224 resolution and fine-tuned on higher resolution of 512.

TABLE 6

| | | | | | Batch | Batch | |
|---|---|---|---|---|---|---|---|
| | | | | Batch (B = 1) | (B = 16) | (B = 64) | |
| | | | | Throughput | Throughput | Throughput | Top-1 |
| Architecture | Resolution | Params | MACs | (images/s) | (images/s) | (images/s) | Accuracy |
| MaxViT-T | 512 | 31M | 33.7G | 71 | 552 | 583 | 85.72% |
| MaxViT-S | 512 | 69M | 67.6G | 72 | 361 | 364 | 86.19% |
| MaxViT-B | 512 | 120M | 138.5G | 37 | 202 | 206 | 86.66% |
| MaxViT-L | 512 | 212M | 245.4G | 36 | 149 | 153 | 86.70% |
| AsCAN-T | 512 | 55M | 40.3G | 210 | 640 | 670 | 85.34% |
| AsCAN-B | 512 | 98M | 87.4G | 118 | 320 | 335 | 86.13% |
| AsCAN-L | 512 | 173M | 160.6G | 104 | 202 | 204 | 86.41% |

The top-1 accuracy is reported on the single center crop image. For training ImageNet-1K models with 224×224 resolution, the AdamW optimizer is used with a peak learning rate of 3e-3 for 300 epochs. A batch size of 4096 images is used during this training period. A cosine schedule is followed for decaying the learning rate to a minimum learning rate of 5e-6. A learning rate warm up was performed to avoid instabilities during the training. A 20 epoch warm up schedule was followed with an initial learning rate of 5e-7 that gets warmed up to the peak learning rate.

For all experiments, standard data augmentation strategies were used. RandAugment was used with parameters (2,15), MixUp with α=0.8, color jittering with 0.4 as the weight and label smoothing with 0.1 as the smoothing parameter. A 0.05 value was used for the weight decay regularization. An exponential model averaging with a decay value of 0.9999 was used. In addition, gradient clipping with gradient norm of 1.0 was performed to avoid instabilities during training of such large models. Stochastic depth was enabled for regularization. The stochastic depth of 0.3/0.4/0.5 was used for the three variants in the experiments. Similarly, while scaling the pre-trained models to larger resolution the experiments started with weights from 224 resolution training. The relative position embeddings was interpolated to the larger resolution and pre-trained weights were fine-tuned for 90 epochs with constant learning rate of 5e-5 with 512 batch size and one epoch warm up. A similar exponential moving average, stochastic depth and weight decay were also used during this procedure as the initial training.

The effects of pre-training the AsCAN family on larger dataset such as ImageNet-21K was also studied. The models were pre-trained on the ImageNet-21K dataset. The pre-processed version of this dataset was used for ease of usage. The AsCAN model was trained for 90 epochs on the ImageNet-21K dataset and the weights were fine-tuned on the ImageNet-1K classification task. Similar to the ImageNet-1K experiments, RandAugment was used with parameters (2,5), MixUp with α=0.2, color jittering with 0.4 as the weight and label smoothing with 0.01 as the smoothing parameter. 0.01 was used for the weight decay regularization. An exponential model averaging with a decay value of 0.9999 was also used. In addition, gradient clipping was performed with gradient norm of 1.0 to avoid instabilities during training of such large models. Stochastic depth was enabled for regularization. The stochastic depth of 0.4/0.5/0.6 was used for the three variants in the experiments.

Table 7 illustrates the performance for ImageNet-21k pre-training where similar top-1 accuracy was observed as for the other baselines but with much better inference throughput. This trend is similar to the one observed above when these models were trained only on the ImageNet-1K dataset without any pre-training on the ImageNet-21K dataset. Table 7 illustrates the performance of models pre-trained on ImageNet-21K with 224 resolution and fine-tuned on the ImageNet-1K dataset. The inference latency is reported as the throughput (images per second) that is measured by inferring images with batch size as B in half-precision, i.e., fp16, on an A100 GPU using torch-compile and benchmark utility from the timm library.

TABLE 7

| | | | | | Batch | Batch | |
|---|---|---|---|---|---|---|---|
| | | | | Batch (B = 1) | (B = 16) | (B = 64) | |
| | | | | Throughput | Throughput | Throughput | Top-1 |
| Architecture | Resolution | Params | MACs | (images/s) | (images/s) | (images/s) | Accuracy |
| ConvNeXt-L | 224 | 198M | 34.4G | 168 | 1045 | 1127 | 86.6% |
| MaxViT-L | 224 | 212M | 43.9G | 34 | 544 | 759 | 86.7% |
| FasterViT-4 | 224 | 425M | 36.6G | 50 | 800 | 1392 | 86.6% |
| AsCAN-L | 224 | 173M | 30.7G | 120 | 1381 | 1617 | 86.7% |

### COCO Object Detection & Instance Segmentation

Experimental Setup. Cascade R-CNN was trained as detection architecture with the AsCAN serving as the backbone pre-trained on the ImageNet-1K dataset. The AdamW optimizer was used with a learning rate 2e-4 and weight decay 0.05. The 3× schedule was used in the mmdetection library. These networks were trained on 8 NVIDIA A100 GPUs using 16 as the batch size, i.e., 2 samples per GPUs.

Experimental Results. Table 8 illustrates the performance of the AsCAN architecture against various baselines on the computer vision task. It shows that the AsCAN architecture can achieve competitive performance on the mean average precision metric across different model sizes, while being faster than the other backbones.

Object detection experiments were based on the widely used and publicly available mmdetection library and the MSCOCO dataset. The Cascade Mask-RCNN was used as the object detection architecture wherein different hybrid architectures are used as the backbones to extract the spatial feature maps. The spatial feature maps were extracted at stages S2, S3, and S4, and these feature maps were forwarded to the detection network. All three AsCAN variants (tiny, base, large) were initialized with the weights pre-trained on the ImageNet-1K task with 224×224 resolution. A 3× schedule was followed for training these detection models with an AdamW optimizer with learning rate of 1e-4, and a weight decay of 0.05. A batch size of 16 ws used on 8 A100 GPUs. Stochastic depth similar to ImageNet was used for training for controlling overfitting during the experiments.

Table 8 illustrates a comparison of different backbones on the detection and segmentation dataset with Cascade Mask RCNN pipeline on COCO va12017. All models were trained with 3× schedule.

TABLE 8

| | Latency | | | | | | | |
|---|---|---|---|---|---|---|---|---|
| | (frames/s) | MACs | | | | | | |
| Backbone | A100 | (G) | AP^{box} | AP^{box}₅₀ | AP^{box}₇₅ | AP^{mask} | AP^{mask}₅₀ | AP^{mask}₇₅ |
| Swin-T | 12.2 | 745 | 50.4 | 69.2 | 54.7 | 43.7 | 66.6 | 47.3 |
| ConvNeXt-T | 13.5 | 741 | 50.4 | 69.1 | 54.8 | 43.7 | 66.5 | 47.3 |
| FasterViT-2 | 15.6 | — | 52.1 | 71.0 | 56.6 | 45.2 | 68.4 | 49.0 |
| AsCAN -T | 18.4 | 790 | 50.3 | 69.7 | 54.8 | 44.2 | 67.5 | 47.4 |
| Swin-S | 11.4 | 838 | 51.9 | 70.7 | 56.3 | 45.0 | 68.2 | 48.8 |
| ConvNeXt-S | 12.0 | 827 | 51.9 | 70.8 | 56.5 | 45.0 | 68.4 | 49.1 |
| FasterViT-3 | 13.5 | — | 52.4 | 71.1 | 56.7 | 45.4 | 68.7 | 49.3 |
| AsCAN -B | 15.6 | 887 | 51.6 | 70.5 | 55.9 | 44.8 | 68.1 | 48.4 |
| Swin-B | 10.7 | 982 | 51.9 | 70.5 | 56.4 | 45.0 | 68.1 | 48.9 |
| ConvNeXt-B | 11.5 | 964 | 52.7 | 71.3 | 57.2 | 45.6 | 68.9 | 49.5 |
| FasterViT-4 | 12.1 | — | 52.9 | 71.6 | 57.7 | 45.8 | 69.1 | 49.8 |
| AsCAN -L | 14.1 | 1045 | 52.4 | 71.3 | 56.7 | 45.2 | 68.4 | 49.3 |

### ADE20K Semantic Segmentation

Experimental Setup. UperNet was trained as segmentation architecture on the ADE20K dataset. AsCAN was used as the backbone pre-trained on the ImageNet-1K dataset. The AdamW optimizer was used with a learning rate 1e-4 and a weight decay 0.05. The models were trained for 160K iterations using the mmsegmentation library. These networks were trained on 8 NVIDIA A100 GPUs using 16 as the batch size. The various inference statistics were computed with 512×512 as the image resolution.

Experimental Results. The performance of various backbones are compared in Table 9. Table 9 shows that the AsCAN backbone achieves competitive mIoU while achieving nearly 1.5× faster inference latency compared to the baselines, measured using the frames per second metrics. This fact can be observed across different scaling of the backbones. For instance, the Swin-T backbone achieves latency of 44FPS while AsCAN-T achieves 64FPS as the latency with similar mIoU. Thus, the AsCAN models achieve a similar performance-versus-latency trend at the downstream semantic segmentation task as the classification benchmark.

The semantic segmentation experiments were based on the widely used and publicly available mmsegmentation library. UPerNet was used as the semantic segmentation architecture wherein different hybrid architectures are used as the backbones to extract the spatial feature maps. The spatial feature maps were extracted at stages S2, S3, and S4, and these feature maps were forwarded to the semantic segmentation network. All three AsCAN variants (tiny, base, large) were initialized with the weights pre-trained on the ImageNet-1K task with 224×224 resolution. Training was performed in 512×512 resolution. A schedule for training these segmentation models included an AdamW optimizer with learning rate of 1e-4 and a weight decay of 0.05. A batch size of 16 was used on 8 A100 GPUs. Stochastic depth similar to ImageNet training was used for controlling overfitting during these experiments.

Table 9 compares different backbones on the ADE20K semantic segmentation benchmark with UPerNet as the detection architecture. Computational and storage statistics are computed using the input resolution of 512×512.

TABLE 9

| | Latency | Latency | | | |
|---|---|---|---|---|---|
| | (frames/s) | (frames/s) | | MACs | |
| Backbone | A100 | V100 | Params | (G) | mIoU |
| Swin-T | 44 | 23 | 60M | 237 | 44.5 |
| FasterViT-2 | 47 | 25 | — | — | 47.2 |
| AsCAN -T | 64 | 30 | 86M | 264 | 47.3 |
| Swin-S | 27 | 16 | 81M | 261 | 47.7 |
| FasterViT-3 | 34 | 19 | — | — | 48.7 |
| AsCAN -B | 44 | 24 | 128M | 311 | 48.9 |
| Swin-B | 23 | 13 | 121M | 301 | 48.1 |
| FasterViT-4 | 28 | 15 | — | — | 49.1 |
| AsCAN -L | 36 | 19 | 204M | 397 | 50.3 |

The neural network architecture described herein includes hybrid architectures comprising convolutional and transformer blocks to solve computer vision tasks. A simple hybrid model is provided with better throughput and performance trade-offs. Instead of designing efficient alternatives to the convolutional and transformer (mainly attention mechanism) blocks, existing vanilla attention blocks along with the FusedMBConv block are leveraged to design the architecture, referred to as AsCAN, which includes an uneven distribution of the convolutional and transformer blocks in the different stages of the network. This distribution is referred to herein as asymmetric in the sense that it favors more convolutional blocks in the early stages with a mix of few transformer blocks, while it reverses this trend favoring more transformer blocks in the later stages with fewer convolutional blocks. The AsCAN architecture is shown through extensive evaluations across the image recognition task (ImageNet-1K dataset) as well as the downstream object detection (MSCOCO) and semantic segmentation (ADE20K) to be superior to existing approaches. The AsCAN model also may be used for image and video generation applications.

### Processing Platform

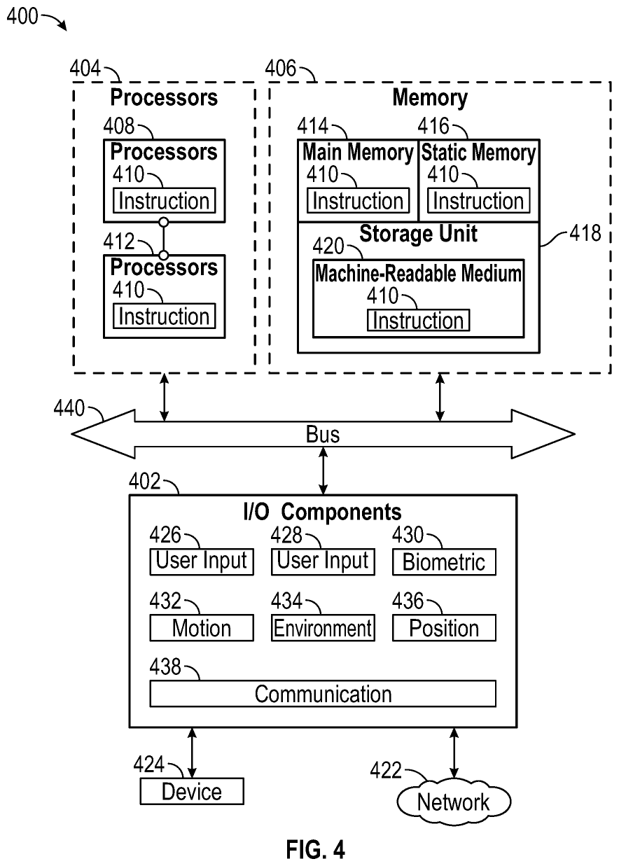

FIG. 4 is a diagrammatic representation of the machine 400 within which instructions 410 (e.g., software, a program, an application, an applet, an app, or other executable code) for causing the machine 400 to perform one or more of the methodologies discussed herein may be executed. For example, the instructions 410 may cause the machine 400 to execute one or more of the methods described herein. The instructions 410 transform the general, non-programmed machine 400 into a particular machine 400 programmed to carry out the described and illustrated functions in the manner described. The machine 400 may operate as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may include, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform one or more of the methodologies discussed herein. The machine 400, for example, may implement the AsCAN architectures of FIGS. 1A-1C. In some examples, the machine 400 may also include both client and server systems, with certain operations of a particular method or algorithm being performed on the server-side and with certain operations of the particular method or algorithm being performed on the client-side.

The machine 400 may include processors 404, memory 406, and input/output I/O components 402, which may be configured to communicate with each other via a bus 440. In an example, the processors 404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 408 and a processor 412 that execute the instructions 410. The term “processor” is intended to include multi-core processors that may include two or more independent processors (sometimes referred to as “cores”) that may execute instructions contemporaneously. Although FIG. 4 shows multiple processors 404, the machine 400 may include a single processor with a single core, a single processor with multiple cores (e.g., a multi-core processor), multiple processors with a single core, multiple processors with multiples cores, or any combination thereof.

The memory 406 includes a main memory 414, a static memory 416, and a storage unit 418, both accessible to the processors 404 via the bus 440. The main memory 406, the static memory 416, and storage unit 418 store the instructions 410 for one or more of the methodologies or functions described herein. The instructions 410 may also reside, completely or partially, within the main memory 414, within the static memory 416, within machine-readable medium 420 within the storage unit 418, within at least one of the processors 404 (e.g., within the Processor's cache memory), or any suitable combination thereof, during execution thereof by the machine 400.

The I/O components 402 may include a wide variety of components to receive input, provide output, produce output, transmit information, exchange information, capture measurements, and so on. The specific I/O components 402 that are included in a particular machine will depend on the type of machine. For example, portable machines such as mobile phones may include a touch input device or other such input mechanisms, while a headless server machine will likely not include such a touch input device. It will be appreciated that the I/O components 402 may include many other components that are not shown in FIG. 4. In various examples, the I/O components 402 may include user output components 426 and user input components 428. The user output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 402 may include biometric components 430, motion components 432, environmental components 434, or position components 436, among a wide array of other components. For example, the biometric components 430 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 432 include acceleration sensor components (e.g., accelerometer), gravitation sensor components, rotation sensor components (e.g., gyroscope).

Any biometric data collected by the biometric components 430 is captured and stored with only user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The environmental components 434 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

The position components 436 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 402 further include communication components 438 operable to couple the machine 400 to a network 422 or devices 424 via respective coupling or connections. For example, the communication components 438 may include a network interface Component or another suitable device to interface with the network 422. In further examples, the communication components 438 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 424 may be another machine or any of a wide variety of peripheral devices (e.g., a peripheral device coupled via a USB).

Moreover, the communication components 438 may detect identifiers or include components operable to detect identifiers. For example, the communication components 438 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 438, such as location via Internet Protocol (IP) geolocation, location via Wi-Fi® signal triangulation, location via detecting an NFC beacon signal that may indicate a particular location, and so forth.

The various memories (e.g., main memory 414, static memory 416, and memory of the processors 404) and storage unit 418 may store one or more sets of instructions and data structures (e.g., software) embodying or used by one or more of the methodologies or functions described herein. These instructions (e.g., the instructions 410), when executed by processors 404, cause various operations to implement the disclosed examples.

The instructions 410 may be transmitted or received over the network 422, using a transmission medium, via a network interface device (e.g., a network interface component included in the communication components 438) and using any one of several well-known transfer protocols (e.g., hypertext transfer protocol (HTTP)). Similarly, the instructions 410 may be transmitted or received using a transmission medium via a coupling (e.g., a peer-to-peer coupling) to the devices 424.

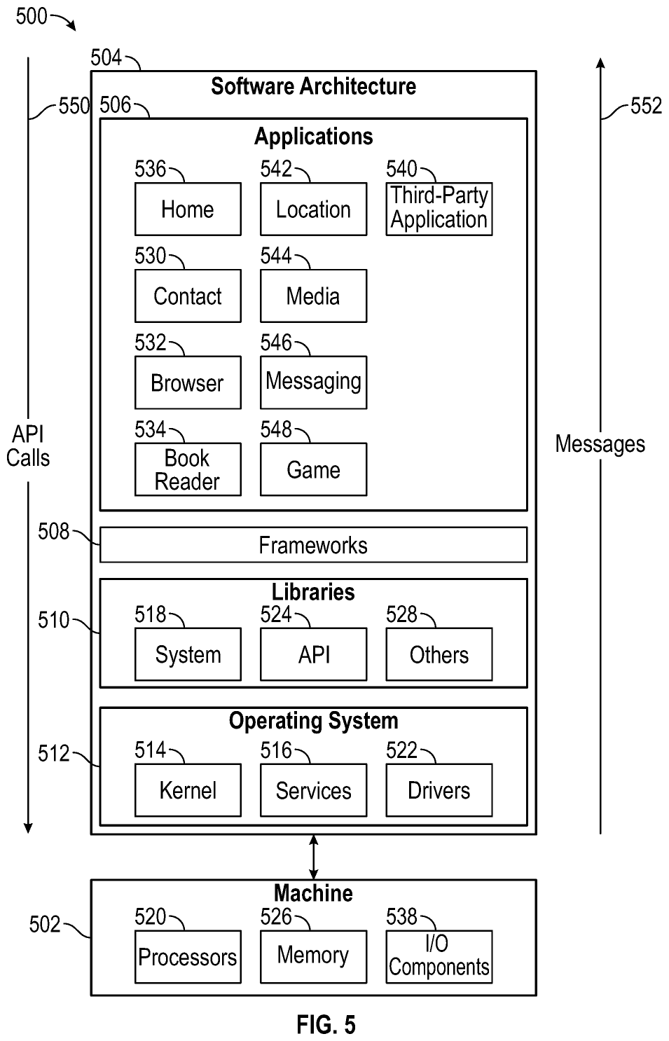

FIG. 5 is a block diagram 500 illustrating a software architecture 504, which can be installed on one or more of the devices described herein. The software architecture 504 is supported by hardware such as a machine 502 (see FIG. 4) that includes processors 520, memory 526, and I/O components 538. In this example, the software architecture 504 can be conceptualized as a stack of layers, where each layer provides a particular functionality. The software architecture 504 includes layers such as an operating system 512, libraries 510, frameworks 508, and applications 506. Operationally, the applications 506 invoke API calls 550 through the software stack and receive messages 552 in response to the API calls 550.

The operating system 512 manages hardware resources and provides common services. The operating system 512 includes, for example, a kernel 514, services 516, and drivers 522. The kernel 514 acts as an abstraction layer between the hardware and the other software layers. For example, the kernel 514 provides memory management, processor management (e.g., scheduling), component management, networking, and security settings, among other functionality. The services 516 can provide other common services for the other software layers. The drivers 522 are responsible for controlling or interfacing with the underlying hardware. For instance, the drivers 522 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 510 provide a common low-level infrastructure used by the applications 506. The libraries 510 can include system libraries 518 (e.g., C standard library) that provide functions such as memory allocation functions, string manipulation functions, mathematic functions, and the like. In addition, the libraries 510 can include API libraries 524 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 510 can also include a wide variety of other libraries 528 to provide many other APIs to the applications 506.

The frameworks 508 provide a common high-level infrastructure that is used by the applications 506. For example, the frameworks 508 provide various graphical user interface (GUI) functions, high-level resource management, and high-level location services. The frameworks 508 can provide a broad spectrum of other APIs that can be used by the applications 506, some of which may be specific to a particular operating system or platform.

In an example, the applications 506 may include a home application 536, a contacts application 530, a browser application 532, a book reader application 534, a location application 542, a media application 544, a messaging application 546, a game application 548, and a broad assortment of other applications such as a third-party application 540. The applications 506 are programs that execute functions defined in the programs. Various programming languages can be employed to generate one or more of the applications 506, structured in a variety of manners, such as object-oriented programming languages (e.g., Objective-C, Java, or C++) or procedural programming languages (e.g., C or assembly language). In a specific example, the third-party application 540 (e.g., an application developed using the ANDROID™ or IOS™ software development kit (SDK) by an entity other than the vendor of the particular platform) may be mobile software running on a mobile operating system such as IOS™, ANDROID™ WINDOWS® Phone, or another mobile operating system. In this example, the third-party application 540 can invoke the API calls 550 provided by the operating system 512 to facilitate functionality described herein.

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component includes a general-purpose processor configured by software to become a special-purpose processor, the general-purpose processor may be configured as respectively different special-purpose processors (e.g., including different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method of performing a computer task on input data using an asymmetrically distributed convolution-attention neural network, comprising:
providing the input data to a convolutional stem;
providing output of the convolutional stem to a first processing stage comprised of convolutional (C) blocks;
providing an output of the first processing stage to one or more early asymmetric processing stages having more C blocks than transformer (T) blocks out of a total number of blocks N;
providing output of the one or more early asymmetric processing stages to one or more late asymmetric processing stages having more T blocks than C blocks out of the total number of blocks N; and
providing output of the one or more late asymmetric processing stages as a result of the computer task.

2. The method of claim 1, further comprising pooling the output of the one or more late asymmetric processing stages and classifying a result of the pooling as the result of the computer task.

3. The method of claim 1, wherein at least one of the one or more early asymmetric processing stages comprises a number of C blocks ranging from 60% to 90% of N and a number of T blocks ranging from 40% to 10% of N, respectively.

4. The method of claim 3, wherein at least one of the one or more late asymmetric processing stages comprises a percentage of T blocks and C blocks that is reversed from the percentage of T blocks and C blocks used in the at least one of the one or more early asymmetric processing stages.

5. The method of claim 4, wherein the at least one of the one or more early asymmetric processing stages comprises 75% C blocks and 25% T blocks, and the at least one of the one or more late asymmetric processing stages comprises 25% C blocks and 75% T blocks.

6. The method of claim 5, wherein the at least one of the one or more early asymmetric processing stages and the at least one of the one or more late asymmetric processing stages together comprise at least three processing stages comprising a second processing stage arranged as CCCT, a third processing stage where an equal number of C blocks and T blocks are used, and a fourth processing stage arranged as CTTT.

7. The method of claim 4, wherein the at least one of the one or more early asymmetric processing stages and the at least one of the one or more late asymmetric processing stages together comprise at least three processing stages comprising a second processing stage arranged as CCCCTT, a third processing stage where an equal number of C blocks and T blocks are used, and a fourth processing stage arranged as CCTTTTT.

8. The method of claim 4, wherein the at least one of the one or more early asymmetric processing stages and the at least one of the one or more late asymmetric processing stages together comprise at least three processing stages comprising a second processing stage arranged as CCCCCCCCCT, a third processing stage where an equal number of C blocks and T blocks are used, and a fourth processing stage arranged as CTTTTTTTTT.

9. The method of claim 1, further comprising arranging the first processing stage, the one or more early asymmetric processing stages, and the one or more late asymmetric processing stages in a processing pipeline whereby any C blocks in each processing stage are placed before any T blocks in each processing stage in the processing pipeline.

10. A neural network that performs a computer task, comprising:
a convolutional stem that receives input data;
a first processing stage comprised of convolutional (C) blocks that receives an output of the convolutional stem;
one or more early asymmetric processing stages having more C blocks than transformer (T) blocks out of a total number of blocks N, the one or more early asymmetric processing stages processing an output of the first processing stage; and
one or more late asymmetric processing stages having more T blocks than C blocks out of the total number of blocks N, the one or more late asymmetric processing stages processing an output of the one or more early asymmetric processing stages to provide a result of the computer task on the input data.

11. The neural network of claim 10, further comprising a pooling and classifier block that pools an output of the one or more late asymmetric processing stages and classifies a result of the pooling as the result of the computer task.

12. The neural network of claim 10, wherein at least one of the one or more early asymmetric processing stages comprises a number of C blocks ranging from 60% to 90% of N and a number of T blocks ranging from 40% to 10% of N, respectively.

13. The neural network of claim 12, wherein at least one of the one or more late asymmetric processing stages comprises a percentage of T blocks and C blocks that is reversed from the percentage of T blocks and C blocks used in the at least one of the one or more early asymmetric processing stages.

14. The neural network of claim 13, wherein the at least one of the one or more early asymmetric processing stages comprises 75% C blocks and 25% T blocks, and the at least one of the one or more late asymmetric processing stages comprises 25% C blocks and 75% T blocks.

15. The neural network of claim 14, wherein the at least one of the one or more early asymmetric processing stages and the at least one of the one or more late asymmetric processing stages together comprise at least three processing stages comprising a second processing stage arranged as CCCT, a third processing stage where an equal number of C blocks and T blocks are used, and a fourth processing stage arranged as CTTT.

16. The neural network of claim 13, wherein the at least one of the one or more early asymmetric processing stages and the at least one of the one or more late asymmetric processing stages together comprise at least three processing stages comprising a second processing stage arranged as CCCCTT, a third processing stage where an equal number of C blocks and T blocks are used, and a fourth processing stage arranged as CCTTTTT.

17. The neural network of claim 13, wherein the at least one of the one or more early asymmetric processing stages and the at least one of the one or more late asymmetric processing stages together comprise at least three processing stages comprising a second processing stage arranged as CCCCCCCCCT, a third processing stage where an equal number of C blocks and T blocks are used, and a fourth processing stage arranged as CTTTTTTTTT.

18. The neural network of claim 10, wherein the first processing stage, the one or more early asymmetric processing stages, and the one or more late asymmetric processing stages are arranged in a processing pipeline and any C blocks in each processing stage are placed before any T blocks in each processing stage in the processing pipeline.

19. The neural network of claim 10, wherein each transformer block comprises a vanilla attention (O(n²) processing block.

20. A non-transitory computer-readable storage medium, the computer-readable storage medium including instructions that when executed by a processor cause the processor to implement a method of performing a computer task on input data using an asymmetrically distributed convolution-attention neural network, by performing operations comprising:
providing the input data to a convolutional stem;
providing output of the convolutional stem to a first processing stage comprised of convolutional (C) blocks;
providing an output of the first processing stage to one or more early asymmetric processing stages having more C blocks than transformer (T) blocks out of a total number of blocks N;
providing output of the one or more early asymmetric processing stages to one or more late asymmetric processing stages having more T blocks than C blocks out of the total number of blocks N; and
pooling the output of the one or more late asymmetric processing stages and classifying a result of the pooling as the result of the computer task.
